(19) United States
(12) Patent Application Publication
(10) Pub. No.: US 2025/0386038 A1
(43) Pub. Date: Dec. 18, 2025

(54) PARTITION DERIVATION OF GEOMETRIC PARTITION

(71) Applicant: Tencent America LLC, Palo Alto, CA (US)

(72) Inventors: Lien-Fei CHEN, Palo Alto, CA (US); Roman CHERNYAK, Santa Clara, CA (US); Biao WANG, San Jose, CA (US); Xin ZHAO, San Jose, CA (US); Shan LIU, San Jose, CA (US)

(73) Assignee: Tencent America LLC, Palo Alto, CA (US)

(21) Appl. No.: 19/301,678

(22) Filed: Aug. 15, 2025

Related U.S. Application Data
(63) Continuation of application No. PCT/US2024/031862, filed on May 31, 2024.
(60) Provisional application No. 63/544,765, filed on Oct. 18, 2023.

(51) Int. Cl. H04N 19/176; H04N 19/119; H04N 19/59; H04N 19/70

(52) U.S. Cl. CPC H04N 19/176; H04N 19/119; H04N 19/59; H04N 19/70

(57) ABSTRACT

An apparatus for video decoding includes processing circuitry configured to receive coded information indicating that a current block is coded with a geometric partitioning mode (GPM) using a first prediction mode and a second prediction mode. Coefficients of a nonlinear polynomial model that indicates a weight w₀ of a first prediction obtained from the first prediction mode are determined based on a current template and reference templates. Each reference template is obtained based on the first prediction mode, the second prediction mode, and a respective candidate nonlinear polynomial model. The nonlinear polynomial model depends on at least one of x and y. (x, y) indicates a sample position in the current block. The current block is reconstructed based on a weighted average of the first prediction and a second prediction of the current block obtained using the second prediction mode according to the weight w₀.

### RELATED APPLICATIONS

The present application is a continuation of International Application No. PCT/US2024/031862, filed on May 31, 2024, which claims the benefit of priority to U.S. Provisional Application No. 63/544,765, “On Partition Derivation of Geometric Partition” filed on Oct. 18, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of the visual media data according to a format rule. The bitstream includes a syntax element indicating that a current block is coded with a geometric partitioning mode (GPM) using a first prediction mode and a second prediction mode. The format rule specifies that coefficients of a nonlinear polynomial model with a degree of 2 are determined based on a current template of the current block and reference templates. The nonlinear polynomial model indicates a weight w₀ of a first prediction of the current block that is obtained from the first prediction mode. The current template includes neighboring reconstructed samples of the current block. The format rule specifies that each reference template is obtained based on the first prediction mode, the second prediction mode, and a respective candidate nonlinear polynomial model with a degree of 2 having corresponding candidate coefficients. The format rule specifies that the nonlinear polynomial model depending on x and y, and (x, y) indicates a sample position in the current block. The format rule specifies that the current block is processed based on a weighted average of the first prediction and a second prediction of the current block obtained using the second prediction mode according to the weight w₀.

In an example, the format rule specifies that w₀ is ax²+bx+cy²+dy+e and a weight w₁ of the second prediction is (1−w₀).

In an aspect, a method for video encoding includes determining whether to apply a geometric partitioning mode (GPM) including a GPM partition method with a weight w₀ to a current block. The weight w₀ is indicated by a nonlinear polynomial model and is of a first prediction of the current block that is obtained from a first prediction mode. The nonlinear polynomial model depends on x and y. (x, y) indicates a sample position in the current block. When the GPM with the weight w₀ indicated by the nonlinear polynomial model is applied to the current block, the method for video encoding includes determining coefficients of the nonlinear polynomial model based on a current template of the current block and reference templates. The current template includes neighboring samples of the current block. Each reference template is obtained based on the first prediction mode, a second prediction mode of the GPM, and a respective candidate nonlinear polynomial model having corresponding candidate coefficients. The method for video encoding includes encoding the current block based on a weighted average of the first prediction and a second prediction of the current block obtained using the second prediction mode according to the weight w₀.

In an example, w₀ is one of ax²+bx+cy²+dy+e and ax³+bx²+cx+dy³+ey²+fy+g, and a weight w₁ of the second prediction is (1−w₀).

According to an aspect of the disclosure, an apparatus for video decoding includes processing circuitry. The processing circuitry is configured to receive coded information indicating that a current block is coded with a geometric partitioning mode (GPM) using a first prediction mode and a second prediction mode. The processing circuitry is configured to determine coefficients of a nonlinear polynomial model that indicates a weight w₀ of a first prediction of the current block that is obtained from the first prediction mode. The coefficients are determined based on a current template of the current block and reference templates. The current template includes neighboring reconstructed samples of the current block. Each reference template is obtained based on the first prediction mode, the second prediction mode, and a respective candidate nonlinear polynomial model having corresponding candidate coefficients. The nonlinear polynomial model depends on at least one of x and y, (x, y) indicating a sample position in the current block. The processing circuitry is configured to reconstruct the current block based on a weighted average of the first prediction and a second prediction of the current block obtained using the second prediction mode according to the weight w₀.

In an example, a degree of the nonlinear polynomial model is 2, w₀=ax²+bx+cy²+dy+e, the determined coefficients include a, b, c, d, and e, and a weight w₁ of the second prediction is (1−w₀).

In an example, a degree of the nonlinear polynomial model is 3, w₀=ax³+bx²+cx+dy³+ey²+fy+g, the determined coefficients include a, b, c, d, e, f, and g, and a weight w₁ of the second prediction is (1−w₀).

In an example, the processing circuitry is configured to determine the coefficients of the nonlinear polynomial model using a regression method.

In an example, the processing circuitry is configured to, prior to determining the coefficients of the nonlinear polynomial model, down-sample an initial current template of the current block having a first resolution to obtain the current template having a second resolution. The second resolution is lower than the first resolution.

In an example, the coded information includes a syntax element indicating whether the weight w₀ is applied to the current block, and the processing circuitry is configured to determine whether the weight w₀ is applied to the current block based on the syntax element.

In an example, the coded information includes a syntax element indicating one of a plurality of types of GPM, and the plurality of types of GPM includes a type of GPM in which the weight w₀ is applied.

In an example, the current template is one of a plurality of templates, and the plurality of templates includes a top template that is directly above the current block, a left template that is directly to the left of the current block, and an L-shaped template including the top template and the left template.

In an example, the coded information includes a syntax element of the current block indicating the current template, and the processing circuitry is configured to determine the current template as the one of the plurality of templates based on the syntax element.

In an example, the coded information includes a syntax element indicating the current template, and the processing circuitry is configured to determine the current template as one of: the L-shaped template when the syntax element is 0, the left template when the syntax element is 1, and the top template when the syntax element is 2.

In an example, the coded information includes a syntax element indicating whether the current template is selected from a plurality of templates, and when the syntax element is determined to indicate that the current template is selected from the plurality of templates, the processing circuitry is configured to determine the current template as one of the plurality of templates based on another syntax element in the coded information.

Aspects of the disclosure also provide an apparatus for video encoding. The apparatus for video encoding includes processing circuitry configured to implement any of the described methods for video encoding.

Aspects of the disclosure also provide a method for video decoding. The method includes any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of intra picture block compensation such as an intra block copy (IBC) mode according to an aspect of the disclosure.

FIG. 5 shows an example of intra picture block compensation with one coding tree unit (CTU) size search range and in some examples reuse of the memory for searching some part of a left CTU according to an aspect of the disclosure.

FIG. 6 shows an example of an intra template matching prediction (IntraTMP) mode according to an aspect of the disclosure.

FIG. 7 shows an example of a first method with two geometric partitions by using a specified partition mode according to an aspect of the disclosure.

FIG. 8 shows examples of splitting lines for a geometric partitioning mode in some examples.

FIG. 9 shows an example of a second method such as a geometric partitioning mode with template matching according to an aspect of the disclosure.

FIG. 10 shows an example of a geometric partition mode including a nonlinear weight indicated by a nonlinear polynomial model used to predict a current block according to an aspect of the disclosure.

FIG. 11 shows an example of using template-matching to determine coefficients of the nonlinear polynomial model in the geometric partition mode according to an aspect of the disclosure.

FIG. 12 shows examples of template types according to an aspect of the disclosure.

FIG. 13 shows a flow chart outlining a decoding process according to some aspects of the disclosure.

FIG. 14 shows a flow chart outlining an encoding process according to some aspects of the disclosure.

FIG. 15 is a schematic illustration of a computer system in accordance with an aspect.

### DETAILED DESCRIPTION

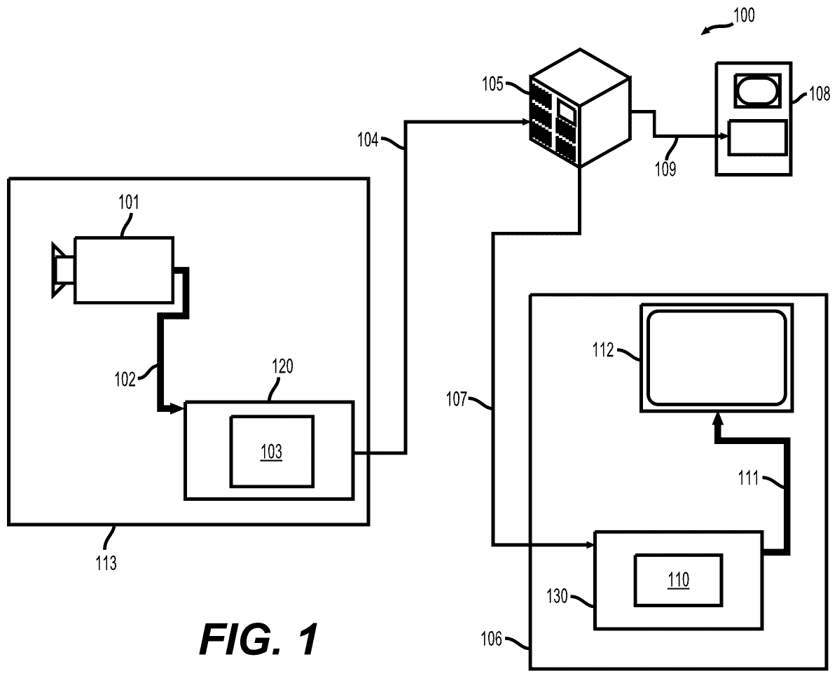

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

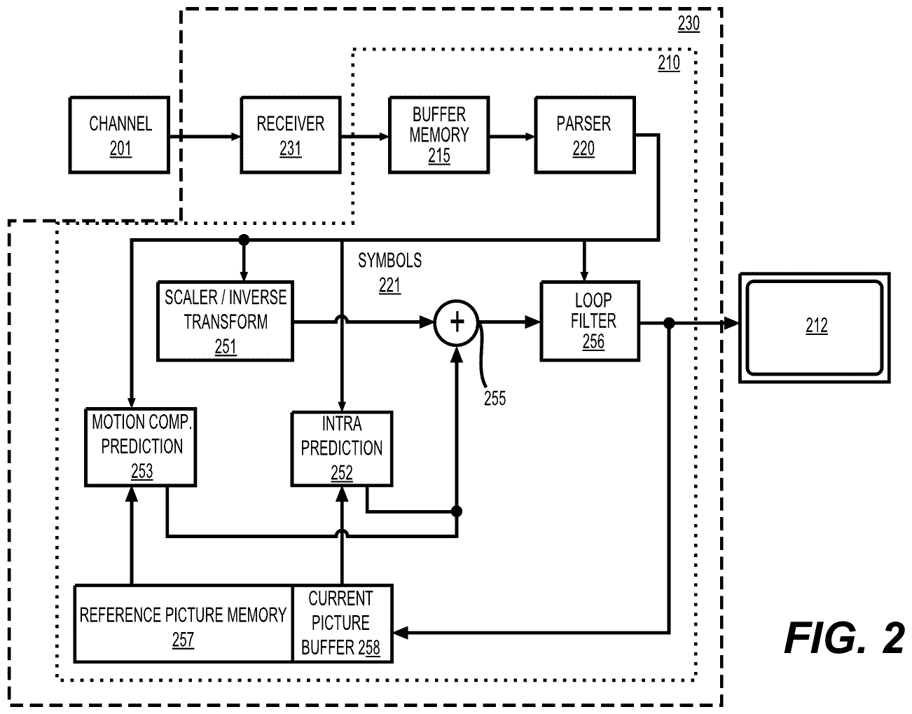

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

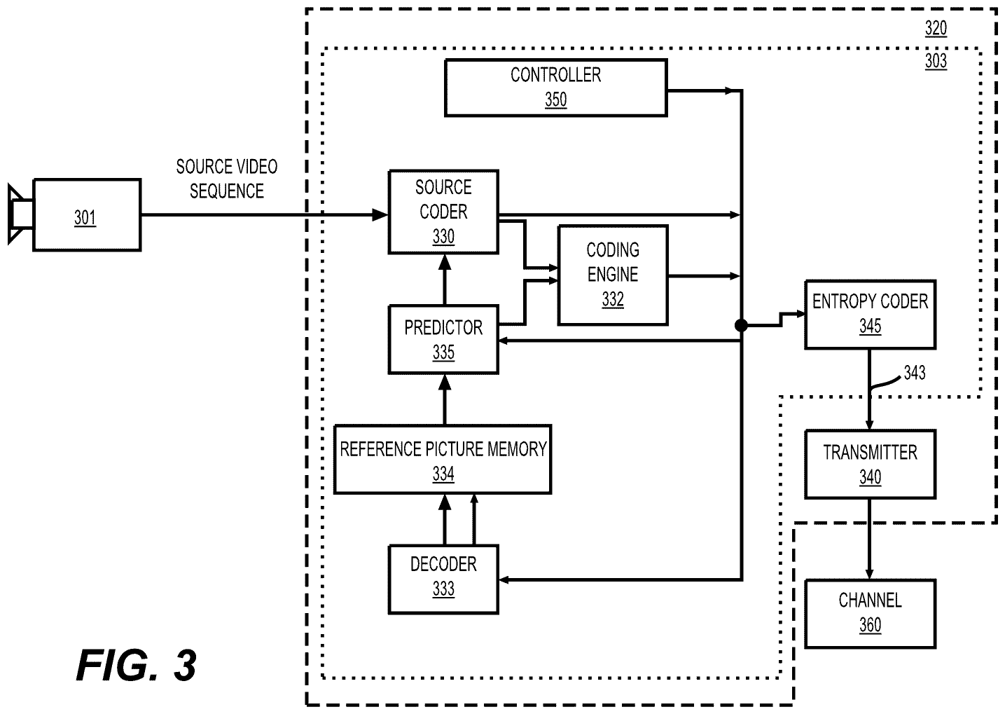

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Video coding has been widely used in applications such as broadcasting, video recording, video streaming, and the like. Emerging video coding standards such as H.264, H.265/HEVC, H.266/VVC, and AV1 are published and widely adopted in the video applications. In an aspect, a hybrid video codec may include the following coding modules, such as intra prediction, inter prediction, transform coding, quantization, entropy coding, post in-loop filter, and the like.

In various examples, a current picture may be used as a reference area of block based compensation, such as in an intra block copy (IBC) mode, an intra template matching prediction (IntraTMP) mode, or the like.

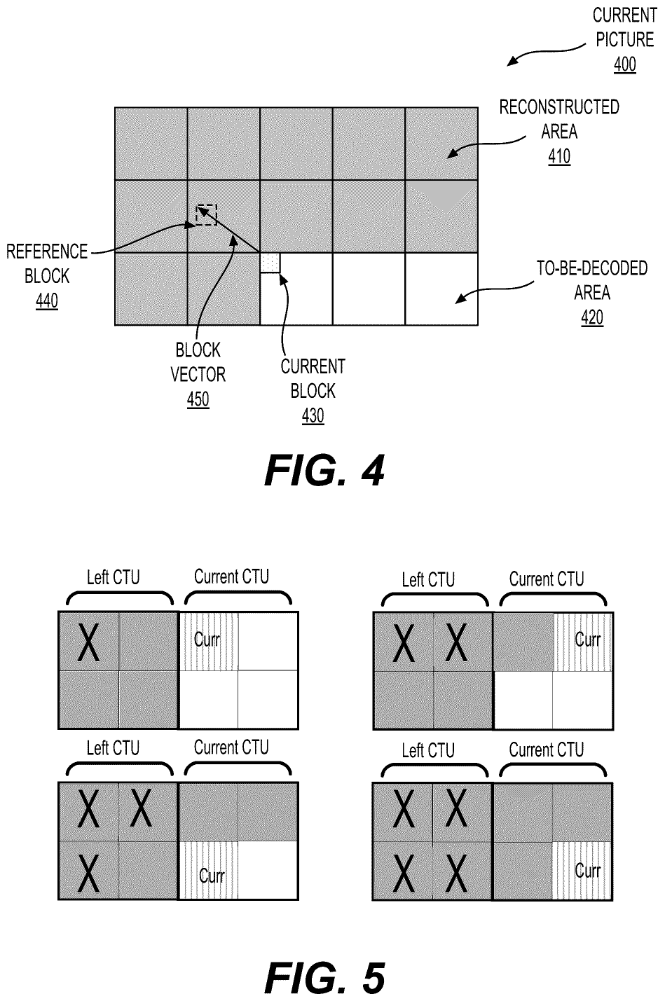

In an aspect, a block compensation can be performed from a previously reconstructed area within the same picture, which may include intra picture block compensation (also referred to as current picture referencing (CPR) or the IBC mode). FIG. 4 shows an example of intra picture block compensation such as the IBC mode according to an aspect of the disclosure. A displacement vector that indicates an offset between a current block (430) and a reference block (440) may be referred as a block vector (BV) (450). The current block (430) and the reference block (440) are in a current picture (400).

Different from a motion vector (MV) in motion compensation, which can be at any value (positive or negative, at either x or y direction), a BV may have a few constraints such that the pointed reference block is available and is already reconstructed. In an example, referring to FIG. 4, the current picture (400) may include a to-be-decoded area (420) and a reconstructed area (410). In an example, a BV may be constrained to point to a reference block in the reconstructed area (410). In some examples, for parallel processing consideration, some reference area that is tile boundary or wavefront ladder shape boundary may be excluded.

The coding of a BV may be either explicit or implicit. In the explicit mode (referred to as an AMVP mode in inter coding), a difference between a BV and a BV predictor may be signaled; in the implicit mode, the BV may be recovered purely from the BV predictor, in a similar way as an MV in a merge mode. The resolution of a BV, in some implementations, may be restricted to integer positions; in other systems, the resolution of a BV may be allowed to point to fractional positions.

The use of intra block copy at a block level, can be signaled using a block level flag, refer as an IBC flag. In an aspect, the IBC flag is signaled when the current block is not coded in the merge mode. In an example, the IBC flag can be signaled by a reference index approach, for example, by treating the current decoded picture as a reference picture. In an example, such as in HEVC SCC, such a reference picture (e.g., the current decoded picture) is put in the last position of a list (e.g., a reference picture list). The special reference picture (e.g., the current decoded picture) may be managed together with other temporal reference pictures in a decoded picture buffer (DPB).

In some examples, the IBC mode may be treated as an inter prediction mode or an intra prediction mode.

There may be some variations for intra block copy, such as treating the intra block copy as a third mode, which is different from either the intra prediction mode or the inter prediction mode. By treating the intra block copy as the third mode, the block vector prediction in the merge mode and the AMVP mode may be separated from the regular inter mode. In an example, the explicit mode described above may be referred to as an IBC AMVP mode, and the implicit mode described above may be referred to as an IBC merge mode. For example, a separate merge candidate list is defined for the IBC mode (e.g., the IBC merge mode), where all the entries in the list are all BVs. Similarly, in an example, the block vector prediction list in the IBC AMVP mode only consists of BVs. In some examples, the general rules applied to both lists include: both lists may follow the same logic as the inter merge candidate list used in the inter mode or the AMVP predictor list used in the inter mode in terms of candidate derivation process. For example, the 5 spatial neighboring locations in inter merge mode such as HEVC or VVC inter merge mode may be accessed for the IBC mode to derive its own merge candidate list.

FIG. 5 shows an example of intra picture block compensation with one CTU size search range and in some examples reuse of the memory for searching some part of a left CTU according to an aspect of the disclosure.

In some examples, such as in VVC, the search range of the IBC mode is constrained to be within a current CTU. In an example, the effective memory requirement to store reference samples for the IBC mode is one CTU size of samples. Considering the existing reference sample memory to store reconstructed samples in a current 64×64 region, 3 more 64×64 sized reference sample memory may be used. Thus, a method may be used to extend the effective search range of the IBC mode to some part of a left CTU while the total memory requirement for storing reference pixels may be kept unchanged, e.g., the total memory requirement is 1 CTU size, such as 4 of 64×64 reference sample memory in total. FIG. 5 shows an example of such a memory reuse mechanism. Each vertical stripped block is a current coding region (Curr), samples in each grey area are coded samples, the cross out regions (marked with “X”) are not available for reference as the cross out regions may be replaced in the reference sample memory by the coding regions in a current CTU.

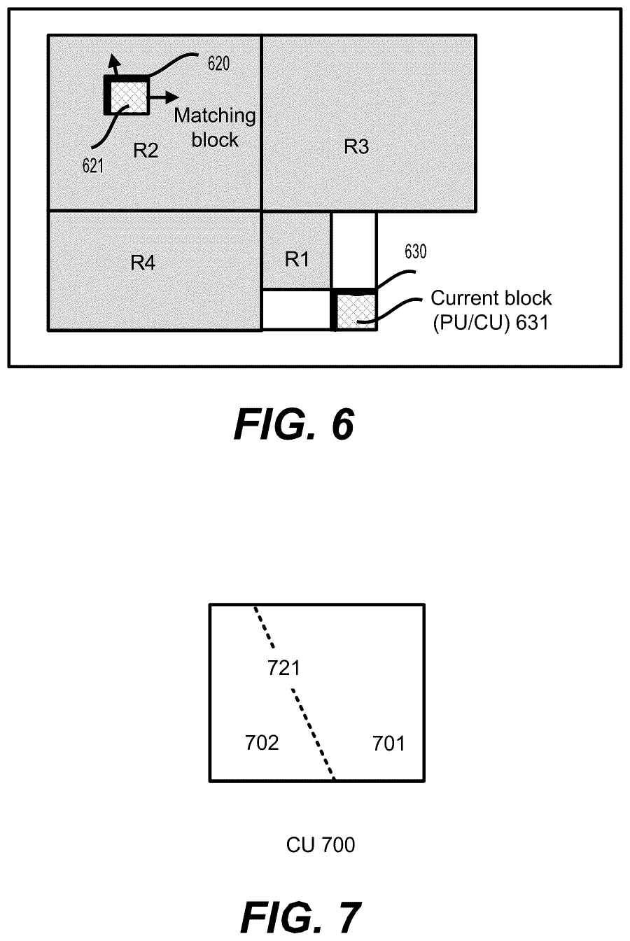

FIG. 6 shows an example of the IntraTMP mode according to an aspect of the disclosure. In an example, the IntraTMP mode is a special intra prediction mode. In an example, the IntraTMP mode is different from the intra prediction mode. Referring to FIG. 6, in an example of the IntraTMP mode, a prediction block (621) such as the best prediction block from a reconstructed part of a current frame may be copied. A template (620) such as an L-shaped template of the prediction block (621) may match a current template (630) of a current block (631). For a predefined search range, the encoder may search for the most similar template to the current template (630) in the reconstructed part of the current frame and may use the corresponding block (621) as a prediction block. In an example, the encoder then signals the usage of the IntraTMP mode, and the same prediction operation is performed at the decoder side.

Referring to FIG. 6, the prediction signal may be generated by matching the L-shaped causal neighbor of the current block (631) with another block in a predefined search area. In an example, the predefined search area includes or consists of: R1 that is a current CTU, R2 that is a top-left CTU of the current CTU, R3 that is an above CTU of the current CTU, and R4 that is a left CTU of the current CTU. In an example, a sum of absolute differences (SAD) is used as a cost function.

Within each region, the decoder may search for a template that has a least cost (e.g., a least SAD) with respect to the current template and may use a block corresponding to the least cost as a prediction block.

The dimensions of all regions (SearchRange_w, SearchRange_h) may be set to be proportional to a block dimension (BlkW, BlkH) to have a fixed number of SAD comparisons per pixel. In an example, SearchRange_w=a×BlkW, and SearchRange_h=a×BlkH, where ‘a’ is a constant that controls a trade-off between gain and complexity. In an example, ‘a’ is equal to 5.

To speed-up the template matching process, in some examples, the search range of all search regions is subsampled, for example, by a factor of 2, and thus leading to a reduction of template matching search by 4. After finding the best match, a refinement process may be performed. The refinement process may be performed via a second template matching search around the best match with a reduced range. In an example, the reduced range is defined as min(BlkW, BlkH)/2.

The intra template matching tool may be enabled for CUs with a size less than or equal to 64 in width and height. The maximum CU size for the IntraTMP mode may be configurable. The IntraTMP mode may be signaled at a CU level through a dedicated flag, for example, when decoder-side intra mode derivation (DIMD) is not used for the current CU.

The term “the IBC mode” may refer to the IBC mode described in the disclosure or a variant. The term “the IntraTMP mode” may refer to the IntraTMP mode described in the disclosure or a variant.

The disclosure includes the partition derivation of geometric partition, which is also called wedge partition, to enhance the signaling and the prediction with geometric partition.

According to an aspect of the disclosure, a first method may be designed to split a block (e.g., a coded block) into two different partitions with a specified partition mode. FIG. 7 shows an example of the first method with two geometric partitions by using a specified partition mode according to an aspect of the disclosure. In the example shown in FIG. 7, a CU (700) is split into two parts or two partitions (701)-(702) by an edge (also referred to as a partition line or a splitting line) (721). Prediction data of the two partitions (701)-(702) may be predicted by using different prediction modes including but not limited to the intra prediction, inter prediction, and an intra block copy (e.g., the IBC mode), the IntraTMP mode, or any suitable mode. The weights of the prediction from the two different prediction modes for each sample may be derived based on a distance between the sample position and the edge (721), for example. An example of the first method is a geometric partitioning mode or a variant. In some examples, a geometric partitioning mode is referred to as the GPM.

In some examples of the GPM, the two partitions (701)-(702) may be predicted using any suitable mode, such as described above in the first method. Each of the two partitions (701)-(702) may be predicted using any suitable mode (e.g., the intra prediction, inter prediction, and the IBC mode, the IntraTMP mode, or the like. In some examples (e.g., VVC), the GPM is supported for inter prediction. The geometric partitioning mode may be signaled using a CU-level flag as one kind of merge mode with other merge modes, such as the regular merge mode, the MMVD mode, the CIIP mode, the subblock merge mode, and the like. In some examples, a total of 64 partitions are supported by geometric partitioning mode for each possible CU size w×h=2^{m}×2ⁿ with m, n∈{3 . . . 6} excluding 8×64 and 64×8.

Referring to FIG. 7, when the GPM is used, the CU (700) is split into the two parts (701)-(702) by the splitting line (721). The splitting line (721) may be a geometrically located straight line.

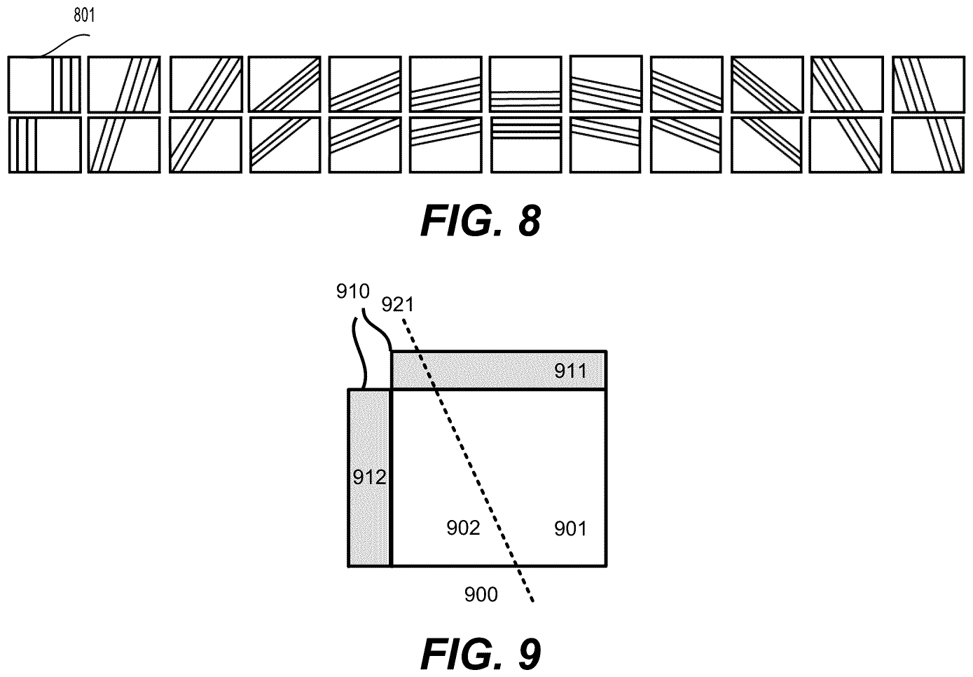

FIG. 8 shows examples of splitting lines for geometric partitioning mode in some examples. The splitting lines are grouped by identical angles. Specifically, each rectangle (801) in FIG. 8 represents a CU. Multiple parallel lines are shown in each rectangle. The multiple parallel lines correspond to splitting lines of an identical angle. In FIG. 8, 3 splitting lines located at different positions in a block are shown for an identical angle. The multiple splitting lines are of different offsets.

The location of a splitting line can be mathematically derived based on the angle and offset parameters of a specific partition. In an example, each of the two geometric partitions formed by the splitting line in the CU is inter-predicted using its own motion. For example, when only uni-prediction is allowed for each partition, each part has one motion vector and one reference index. The uni-prediction constraint (e.g., only uni-prediction is allowed for each partition) may be applied to ensure that a CU in GPM mode can be coded as the conventional bi-prediction, for example, two motion compensated predictions (e.g., each of the two motion compensated predictions corresponds to a uni-prediction) are performed for each CU in the GPM mode.

In some examples, when the GPM is used for the current CU, then a geometric partition index indicating the partition mode of the geometric partition (e.g., indicating angle and offset), and two merge indices (one for each partition) are further signaled. In some examples, the value of maximum GPM candidate size is signaled explicitly in SPS and specifies syntax binarization for GPM merge indices. After predicting each part of the geometric partition, the sample values along the geometric partition edge are adjusted using a blending process with adaptive weights to obtain the prediction signal for the whole CU. Then, transform and quantization processes can be applied to the whole CU as in other prediction modes. Finally, the motion field of a CU predicted using the geometric partition modes is stored.

A second method may be designed to reorder the partition modes by using template-matching (TM) as shown in FIG. 9. FIG. 9 shows an example of the second method according to an aspect of the disclosure. An example of the second method is a variation of the GPM, such as the GPM with TM. According to the second method, a current block or a current CU (900) is split into two partitions (901)-(902) by an edge or a splitting line (921). The partition line (921) may be extended from the current block (900) to a current template (910). The current template (910) may be constructed by using adjacent reconstructed samples of the current block (900). A reference template may be constructed by using adjacent samples of a reference block in a reference picture. Template-matching for each partition mode may be applied on the current template (910) of the current block (900) and a reference template to calculate a corresponding TM cost. Thus, a TM cost may be calculated for each partition mode. The partition mode indices may be reordered based on the TM costs of the partition modes, for example, in an ascending order.

As shown in FIG. 9, template matching may be applied to the GPM. When GPM mode is enabled for a CU, a CU-level flag is signaled to indicate whether the TM is applied to both geometric partitions. Motion information for each geometric partition may be refined using TM. When TM is chosen, a template may be constructed using left, above, or left and above neighboring samples according to a partition angle. The motion may be refined by minimizing the difference between the current template (910) and the template in the reference picture, for example, using the same search pattern of merge mode with half-pel interpolation filter disabled. In the example shown in FIG. 9, the current template (910) may include a top template (911) that includes above neighboring samples of the current block (900) and a left template (912) that includes left neighboring samples of the current block (900). In an example, the current template may consist of the top template (911). In an example, the current template may consist of the left template (912).

In the disclosure, examples of the geometric partition mode include the first method where a block is split into two different partitions. A weight wᵢ (also referred to as a prediction weight or a partition weight) may refer to the weight in the first method (e.g., the geometric partition mode) and i may be either 0 or 1. In an aspect, the weight w₀ may refer to the weight of a first prediction of the current block that is obtained from the first prediction mode, and the weight w₁ may refer to the weight of a second prediction of the current block that is obtained from the second prediction mode. In an aspect, a sum of w₀ and w₁ is 1.

In some examples, a template may refer to the template in a TM method such as the second method. The template, such as a current template adjacent to the current block, may be constructed using adjacent reconstructed samples of the current block. In an example, a reference template may be constructed using adjacent reconstructed samples of the reference block (or a prediction block).

According to an aspect of the disclosure, a geometric partition mode may be applied to a current block. Two different prediction modes, including a first prediction mode and a second prediction mode, may be applied to the current block to generate two predictions including a first prediction P₀ and a second prediction P₁, respectively. One of the first prediction mode and the second prediction mode may be one of an intra prediction mode, an inter prediction mode, the IBC mode, the IntraTMP mode, or the like. The current block may be predicted based on a weighted average of the first prediction P₀ and the second prediction P₁ according to the weights w₀ and w₁, respectively. When the sum of w₀ and w₁ is 1, the weighted average of the first prediction P₀ and the second prediction P₁ is based on w₀ or w₁.

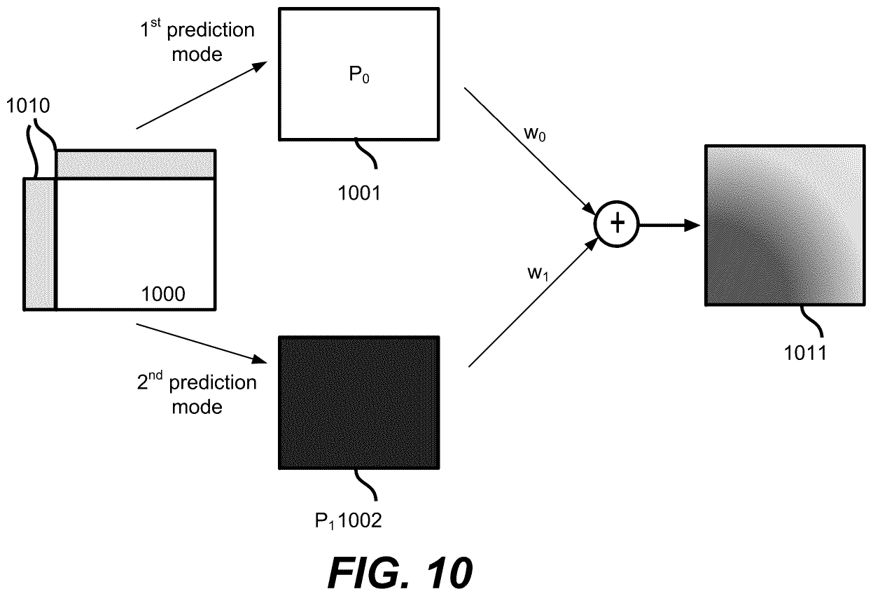

FIG. 10 shows an example of the geometric partition mode used to predict a current block (1000). A first prediction mode is applied to the current block (1000) to generate a first prediction P₀ such as a first prediction block (1001). A second prediction mode is applied to the current block (1000) to generate a second prediction P₁ such as a second prediction block (1002). A prediction (1011) may be generated based on a weighted average of the first prediction P₀ and the second prediction P₁ according to the weights w₀ and w₁, respectively, to predict the current block (1000).

According to an aspect of the disclosure, the weights w₀ and w₁ may have a nonlinear relationship with at least one of x and y where (x, y) indicates the sample position in the current block (1000). Thus, the weights w₀ and w₁ may depend on the at least one of x and y in a nonlinear way, which may be different from some variations of the GPM.

Accordingly, different samples in the current block (1000) may have different weights w₀ (and different weights w₁). According to an aspect of the disclosure, the weight w₀ (and w₁) may be indicated using a polynomial model such as a nonlinear polynomial model, and the weights w₀ and w₁ may be referred to as nonlinear weights. In an aspect, the nonlinear polynomial model has a degree of at least 2, such as 2, 3, or the like.

The polynomial model may be specified according to a degree of the polynomial model, variable(s) (e.g., x and/or y) in the polynomial model, and coefficients of each term in the polynomial model. The degree of the polynomial model may be an integer that is larger than 1, such as 2, 3, or the like. The variable(s) in the polynomial model may include (i) one variable such as x or y or (ii) multiple variables such as x and y. In an example, the polynomial model may be determined by templating matching, for example, by matching a current template of the current block to one of reference templates, and thus the GPM described in FIG. 10 may be referred to as a regression-based GPM. The reference templates may be determined using candidate polynomial models.

According to an aspect of the disclosure, coefficients of the nonlinear polynomial model that indicates the weight w₀ may be determined based on the current template of the current block and the reference templates by template-matching. The current template may include neighboring reconstructed samples of the current block. An example of the current template is a current template (1010) of the current block (1000) as shown in FIG. 10. Each reference template may be obtained based on the first prediction mode, the second prediction mode, and a respective candidate nonlinear polynomial model (e.g., an i-th candidate nonlinear polynomial model) having corresponding candidate coefficients. In an example, each candidate nonlinear polynomial model and the nonlinear polynomial model have the same type of dependence on the at least x and y (e.g., the same degree and the same variable(s)) and different coefficients. For example, in the nonlinear polynomial model, w₀=ax²+bx+cy²+dy+e and in the i-th candidate nonlinear polynomial model, w₀ᵢ=aᵢx²+bᵢx+cᵢ+dᵢy+eᵢ. The i-th candidate nonlinear polynomial model and the nonlinear polynomial model have the same degree of 2, and depend on x and y. The coefficients of the i-th candidate nonlinear polynomial model include aᵢ, bᵢ, cᵢ, dᵢ, and eᵢ. The coefficients of the nonlinear polynomial model include a, b, c, d, and e.

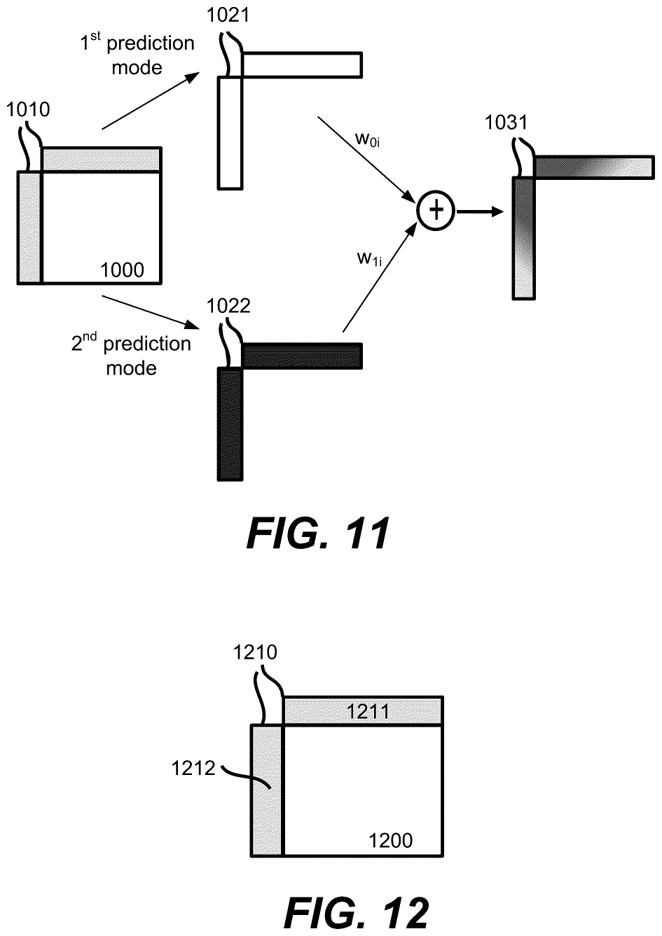

FIG. 11 shows an example of using template-matching to determine the coefficients of the nonlinear polynomial model in the geometric partition mode according to an aspect of the disclosure. The current block (1000) is predicted using the geometric partition mode as described in FIG. 10. In an example, prior to predicting the current block (1000), the coefficients of the nonlinear polynomial model that indicates the weight w₀ are determined such as described below. Multiple candidate nonlinear polynomial models having corresponding candidate coefficients may be determined. As described above, each candidate nonlinear polynomial model and the nonlinear polynomial model may have the same type of dependence on x and y and may have different coefficients. For each candidate nonlinear polynomial model, a first reference template (1021) of the current template (1010) may be predicted based on the first prediction mode. A second reference template (1022) of the current template (1010) may be predicted based on the second prediction mode. For an i-th pair of weights w₀ᵢ and w₁ᵢ (e.g., w₁ᵢ=1−w₀ᵢ) where w₀ᵢ is indicated by the i-th candidate nonlinear polynomial model, a reference template (1031) of the current template (1010) is determined based on a weighted sum of the first reference template (1021) and the second reference template (1022) according to w₀ᵢ and w₁ᵢ, respectively. A TM cost associated with the i-th candidate nonlinear polynomial model may be determined based on a comparison of the current template (1010) and the reference template (1031) of the current template (1010). The above process may be performed for each candidate nonlinear polynomial model to obtain the TM costs of the candidate nonlinear polynomial models. In an example, the candidate nonlinear polynomial model with the smallest TM cost may be selected as the nonlinear polynomial model used to predict the current block (1000), and thus the coefficients of the candidate nonlinear polynomial model with the smallest TM cost may be selected as the coefficients of the nonlinear polynomial model.

The geometric partition mode with the template-matched nonlinear weights, such as described in FIGS. 10-11, may be different from some variations of the geometric partition modes such as described in FIGS. 7-9, and thus may be advantageous in some applications. For example, determining the weights w₀ and w₁ using the TM such as shown in FIGS. 10-11 is content-adaptive and takes into consideration the local content neighboring the current block, which may provide more accurate weights w₀ and w₁ and more accurate prediction of the current block. Further, in some variations of GPM, the weights have a linear relationship with at least one of x and y, and thus the splitting line is a straight line. In some examples, the straight line partition (e.g., shown in FIGS. 7-9) may be less accurate than a curved partition, which is indicated by a nonlinear relationship between at least one of x and y and the weights w₀ and w₁ (such as described in FIGS. 10-11). Thus, the GPM with the template-matched nonlinear weights described in the disclosure may have a more accurate prediction of the partition (e.g., a curved partition) and thus increase prediction accuracy.

In an aspect, the partition weights (e.g., w₀ and w₁) may be derived by using the template (e.g., the current template (1010)). In an example, the nonlinear polynomial model such as a polynomial model with degree of 2 or higher may be derived based on the current template (1010) and reference templates, such as described in FIG. 11. The derived nonlinear polynomial model such as the polynomial model with degree of 2 or higher may be applied as the prediction weights (e.g., w₀ and w₁) of each sample in the weighting average of the two prediction modes (e.g., the first prediction mode and the second prediction mode), such as shown in FIG. 10.

In an aspect, the polynomial model with degree of 2 or higher may be indicated using a high-order equation with a square term (e.g., x² or y²) or a high degree term (e.g., x³ or y³) which is higher than the square term. Two examples of the polynomial model are shown as follows. The following polynomial models have the derived coefficients (or parameters), a, b, c, d, e, f, and/or g, and the x and y are the coordinates of a sample in the current block. In an example, a degree of the nonlinear polynomial model is 2, the polynomial equation is w₀=ax²+bx+cy²+dy+e, the determined coefficients include a, b, c, d, and e, and the weight w₁ of the second prediction is (1−w₀). In an example, a degree of the nonlinear polynomial model is 3, the polynomial equation is w₀=ax³+bx²+cx+dy³+ey²+fy+g, the determined coefficients include a, b, c, d, e, f, and g, and the weight w₁ is (1−w₀).

In an aspect, the coefficients in the nonlinear polynomial model are derived by using any regression method such as a least square method, a maximum likelihood method, or the like.

In an aspect, referring to FIG. 11, the derived coefficients in the polynomial model are derived by using the data in the current template (1010) and the reference template (1031). The data in the current template (1010) may include the reconstructed samples in the current template (1010). The data in the reference template (1031) may be derived as described in FIG. 11.

In an example, a subsampling method (e.g., a down-sampling method) may be applied to the coefficients derivation to reduce a number of samples used in the computation, and thus increase computational efficiency. For example, the current template (1010) having a first resolution may be down-sampled prior to deriving the reference template (1031), and thus the current template and the reference templates used in determining the coefficients of the nonlinear polynomial model may have a second resolution that is lower than the first resolution.

In an aspect, a flag at a block level (e.g., a coded block level) is signaled to indicate whether the method (e.g., the GPM using the template-matched nonlinear weights such as described in FIGS. 10-11) is applied to the current block or not. In an example, coded information in a bitstream includes a syntax element (e.g., the flag) indicating whether the weight w₀ indicated by the nonlinear polynomial model is applied to the current block. Whether the weight w₀ is applied to the current block may be determined based on the syntax element.

In an aspect, a syntax is signaled to indicate which GPM partition method (e.g., the GPM using the template-matched nonlinear weights such as described in FIGS. 10-11) is selected and the GPM partition method is one of a plurality of GPM partition methods. In an example, the coded information in the bitstream includes a syntax element indicating one of a plurality of types of GPM, and the plurality of types of GPM may include a type of GPM in which the template-matched nonlinear weight w₀ is applied. In an example, the coefficients of the nonlinear weight w₀ are determined using TM such as described in FIG. 11.

In an aspect, the template can be of different types. In an example, the current template is one of a plurality of templates. Referring to FIG. 12, the plurality of templates may include a top template (1211) that is directly above the current block (1200), a left template (1212) that is directly to the left of the current block, and an L-shaped template (1210) including the top template (1211) and the left template (1212). In some examples, the L-shaped template also includes a top-left corner that is between the top template (1211) and the left template (1212). For example, the current template may include the left template (1212) only, the top template (1211) only, or the L-shaped template (1210), or the like to derive the coefficients of the nonlinear polynomial model (e.g., the polynomial equation).

In an aspect, a flag in the block level (e.g., the coded block level) is signaled to indicate which template type (e.g., the left template only, the top template only, or the L-shape template) is selected to derive the nonlinear polynomial model. For example, the coded information includes a syntax element of the current block indicating the current template. The current template is determined as the one of the plurality of templates (e.g., the top template (1211), the left template (1212), and the L-shaped template (1210)) based on the syntax element.

In an aspect, a flag is signaled to indicate whether a partial template (e.g., the left template (1212), the top template (1211), or the like) may be applied or not. If the flag is true, another syntax is signaled to indicate which template type is used. Otherwise, if the flag is false, a pre-defined template type (e.g., the L shaped template) may be used. In an example, the coded information includes a syntax element indicating whether the current template is selected from the plurality of templates. When the syntax element is determined to indicate that the current template is selected from the plurality of templates, the current template is determined as one of the plurality of templates based on another syntax element in the coded information.

In an aspect, a syntax element is signaled to indicate which kind of template type is used. Table 1 shows an example of the syntax element. In an example, the coded information in the bitstream includes the syntax element indicating the template type of the current template. Referring to FIG. 11, the current template may be determined as one of: the L-shaped template (1210) when the syntax element is 0; the left template (1212) only when the syntax element is 1; and the top template (1211) only when the syntax element is 2.

Table 1 shows an example of the syntax element

| Syntax value | Template type |
|---|---|
| 0 | Left template & Top template |
| 1 | Left template only |
| 2 | Top template only |

In an aspect, the syntax of the template type selection is implicitly signaled to indicate that a template type in the available templates (e.g., the top template (1211), the left template (1212), and the L-shaped template (1210)) is selected when the current block is located at one of the following boundaries including but not limited to a picture boundary, a slice boundary, a tile boundary, a coding tree unit (CTU) boundary, and a superblock boundary, and the like. In an example, which one of the top template, the left template, and the L-shaped template is the current template depends on a location of the current block where the location of the current block may be one of the picture boundary, the slice boundary, the tile boundary, the CTU boundary, and the superblock boundary.

In an aspect, the syntax of the template type selection is implicitly signaled to indicate that a template type in the available templates is selected when a part of the template is not available for the current block. For example, if the top template (e.g., the top part (1211) of the template (1210)) is not available, the only available template is the left template (1212). Thus, the current template is the left template (1212) when the top template (1211) is not available. In an example, the current template is the top template when the left template is not available.

In an aspect, when only the left template (1212) or only the top template (1211) is used to derive the nonlinear polynomial model, a degree of the nonlinear polynomial model is one of 2 and 3, w₀ depends on x and does not depend on y, and the weight w₁ is (1−w₀). In an example, the polynomial equation is w₀=ax²+bx+c and w₁=1−w₀. In an example, w₀=ax³+bx²+cx+d and w₁=1−w₀.

In an aspect, when only the left template (1212) or only the top template (1211) is used to derive the nonlinear polynomial model, a degree of the nonlinear polynomial model may be constrained to one or more pre-defined degrees, such to one of 2 and 3, w₀ depends on y and does not depend on x, and a weight w₁ of the second prediction is (1−w₀). In an example, the polynomial equation is w₀=ay²+by+c and w₁=1−w₀. In an example w₀=ay³+by²+cy+d and w₁=1−w₀.

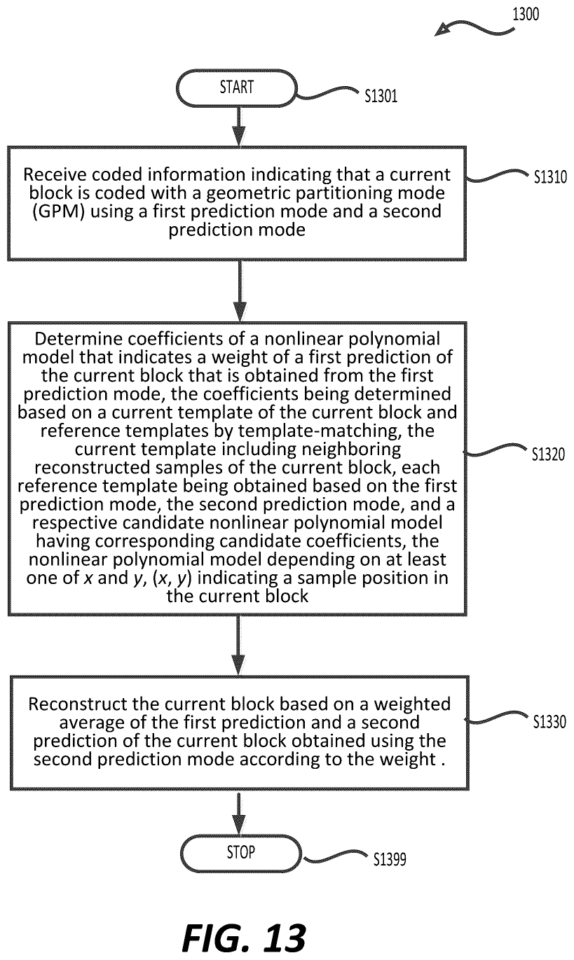

FIG. 13 shows a flow chart outlining a process (1300) according to an aspect of the disclosure. The process (1300) can be used in an apparatus, such as a video decoder. In various aspects, the process (1300) is executed by processing circuitry, such as the processing circuitry that performs functions of the video decoder (110), the processing circuitry that performs functions of the video decoder (210), and the like. In some aspects, the process (1300) is implemented in software instructions, thus when the processing circuitry executes the software instructions, the processing circuitry performs the process (1300). The process starts at (S1301) and proceeds to (S1310).

At (S1310), coded information indicating that a current block is coded with a geometric partitioning mode (GPM) using a first prediction mode and a second prediction mode is received.

At (S1320), a nonlinear polynomial model (e.g., coefficients of the nonlinear polynomial model) may be determined based on a current template of the current block and reference templates by template-matching. The nonlinear polynomial model indicates a weight w₀ of a first prediction of the current block that is obtained from the first prediction mode. In an example, a weight w₁ of the second prediction is (1−w₀). The current template includes neighboring reconstructed samples of the current block. Each reference template may be obtained based on the first prediction mode, the second prediction mode, and a respective candidate nonlinear polynomial model having corresponding candidate coefficients. The nonlinear polynomial model may depend on at least one of x and y. (x, y) indicates a sample position in the current block. In the GPM, the nonlinear weights may be determined using template-matching.

In an example, a degree of the nonlinear polynomial model is 2, w₀=ax²+bx+cy²+dy+e, and the determined coefficients include a, b, c, d, and e.

In an example, a degree of the nonlinear polynomial model is 3, w₀=ax³+bx²+cx+dy³+ey²+fy+g, the determined coefficients include a, b, c, d, e, f, and g.

In an example, the coefficients of the nonlinear polynomial model are determined using a regression method.

In an example, prior to determining the coefficients of the nonlinear polynomial model, an initial current template of the current block having a first resolution is down-sampled to obtain the current template having a second resolution. The second resolution is lower than the first resolution. The template-matching may be performed using the down-sampled current template and the down-sampled reference templates.

At (S1330), the current block is reconstructed based on a weighted average of the first prediction and a second prediction of the current block obtained using the second prediction mode according to the weight w₀.

Then, the process proceeds to (S1399) and terminates.

The process (1300) can be suitably adapted. Step(s) in the process (1300) can be modified and/or omitted. Additional step(s) can be added. Any suitable order of implementation can be used.

In an example, the coded information includes a syntax element indicating whether the weight w₀ is applied to the current block and whether the weight w₀ is applied to the current block is determined based on the syntax element.

In an example, the coded information includes a syntax element indicating one of a plurality of types of GPM, and the plurality of types of GPM includes a type of GPM in which the weight w₀ (e.g., the nonlinear weight w₀ indicated by the nonlinear polynomial model) is applied.

In an aspect, the current template is one of a plurality of templates, and the plurality of templates includes a top template that is directly above the current block, a left template that is directly to the left of the current block, and an L-shaped template including the top template and the left template. In an example, the coded information includes a syntax element of the current block indicating the current template, and the current template is determined as the one of the plurality of templates based on the syntax element. In an example, the coded information includes a syntax element indicating the current template, and the current template is determined as one of: the L-shaped template when the syntax element is 0, the left template when the syntax element is 1, and the top template when the syntax element is 2.

In an example, the coded information includes a syntax element indicating whether the current template is selected from a plurality of templates. When the syntax element is determined to indicate that the current template is selected from the plurality of templates, the current template is determined as one of the plurality of templates based on another syntax element in the coded information.

In an example, which one of a top template that is directly above the current block, a left template that is directly to the left of the current block, and an L-shaped template including the top template and the left template is the current template depends on a location of the current block, and the location of the current block is one of a picture boundary, a slice boundary, a tile boundary, a coding tree unit (CTU) boundary, and a superblock boundary.

In an example, the current template is a top template that is directly above the current block when a left template that is directly to the left of the current block is not available, and the current template is the left template when the top template is not available.

In an example, when the current template is a top template that is directly above the current block or a left template that is directly to the left of the current block, a degree of the nonlinear polynomial model is one of 2 and 3, w₀ depends on x and does not depend on y, and a weight w₁ of the second prediction is (1−w₀).

In an example, when the current template is a top template that is directly above the current block or a left template that is directly to the left of the current block, a degree of the nonlinear polynomial model is one of 2 and 3, w₀ depends on y and does not depend on x, and a weight w₁ of the second prediction is (1−w₀).

In an example, one of the first prediction mode and the second prediction mode is one of an intra prediction mode, an inter prediction mode, an intra block copy (IBC) mode, and an intra template matching (IntraTMP) mode.

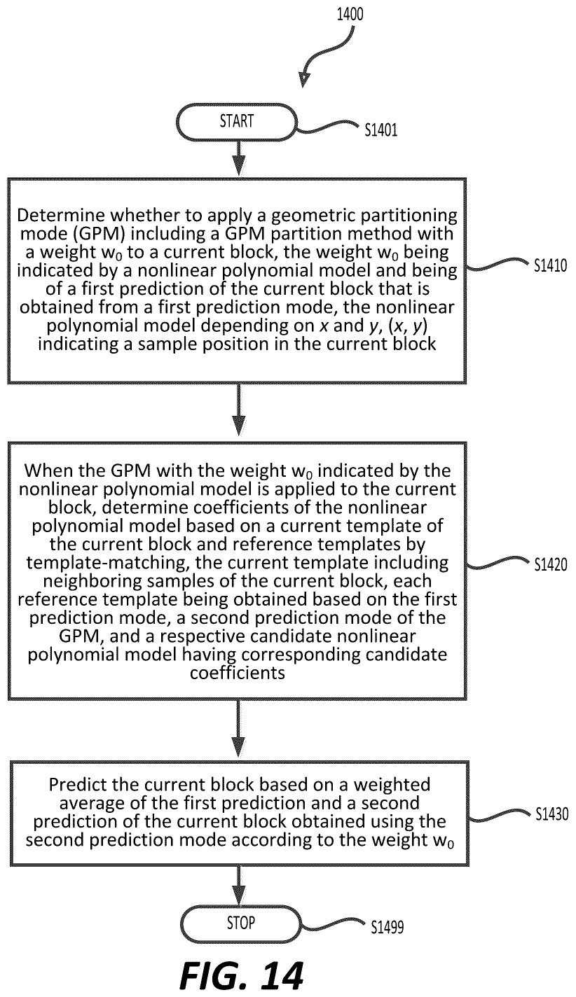

FIG. 14 shows a flow chart outlining a process (1400) according to an aspect of the disclosure. The process (1400) can be used in a video encoder. In various aspects, the process (1400) is executed by processing circuitry, such as the processing circuitry that performs functions of the video encoder (103), the processing circuitry that performs functions of the video encoder (303), and the like. In some aspects, the process (1400) is implemented in software instructions, thus when the processing circuitry executes the software instructions, the processing circuitry performs the process (1400). The process starts at (S1401) and proceeds to (S1410).

At (S1410), whether to apply a geometric partitioning mode (GPM) including a GPM partition method with a weight w₀ to a current block is determined. The weight w₀ may be indicated by a nonlinear polynomial model and may be of a first prediction of the current block that is obtained from a first prediction mode. The nonlinear polynomial model may depend on x and y, where (x, y) indicates a sample position in the current block.

At (S1420), when the GPM with the weight w₀ indicated by the nonlinear polynomial model is applied to the current block, coefficients of the nonlinear polynomial model may be determined based on a current template of the current block and reference templates by template-matching. The current template includes neighboring samples of the current block. Each reference template may be obtained based on the first prediction mode, a second prediction mode of the GPM, and a respective candidate nonlinear polynomial model having corresponding candidate coefficients such as shown in FIG. 11.

In an example, w₀ is one of ax²+bx+cy²+dy+e and ax³+bx²+cx+dy³+ey²+fy+g, and a weight w₁ of the second prediction is (1−w₀).

At (S1430), the current block may be predicted based on a weighted average of the first prediction and a second prediction of the current block obtained using the second prediction mode according to the weight w₀ such as shown in FIG. 10.

Then, the process proceeds to (S1499) and terminates.

The process (1400) can be suitably adapted. Step(s) in the process (1400) can be modified and/or omitted. Additional step(s) can be added. Any suitable order of implementation can be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

The bitstream includes a syntax element indicating that a current block is coded with a geometric partitioning mode (GPM) using a first prediction mode and a second prediction mode. The format rule may specify that coefficients of a nonlinear polynomial model with a degree of 2 are determined based on a current template of the current block and reference templates. The nonlinear polynomial model indicates a weight w₀ of a first prediction of the current block that is obtained from the first prediction mode. The current template includes neighboring reconstructed samples of the current block. The format rule may specify that each reference template is obtained based on the first prediction mode, the second prediction mode, and a respective candidate nonlinear polynomial model with a degree of 2 having corresponding candidate coefficients, such as described in FIG. 11. The format rule may specify that the nonlinear polynomial model depends on x and y, and (x, y) indicates a sample position in the current block. The format rule may specify that the current block is processed based on a weighted average of the first prediction and a second prediction of the current block obtained using the second prediction mode according to the weight w₀.

In an example, the format rule specifies that w₀ is ax²+bx+cy²+dy+e and a weight w₁ of the second prediction is (1−w₀).

The methods, aspects, and examples described in the disclosure may be used separately or combined in any order. For example, some methods, aspects, and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

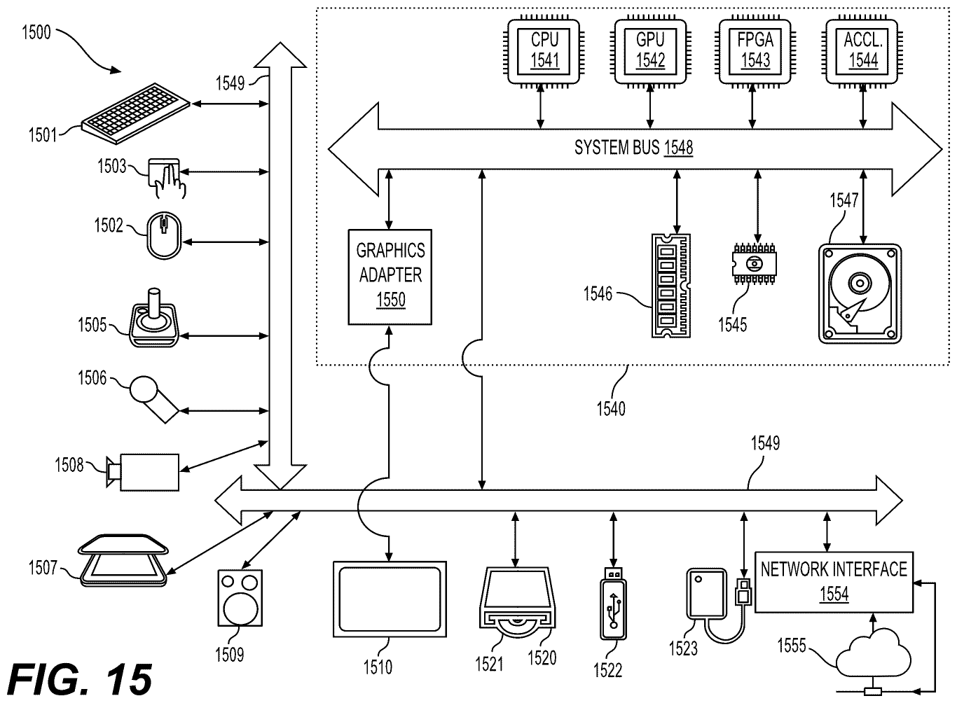

The techniques described above, can be implemented as computer software using computer-readable instructions and physically stored in one or more computer-readable media. For example, FIG. 15 shows a computer system (1500) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 15 for computer system (1500) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1500).

Computer system (1500) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1501), mouse (1502), trackpad (1503), touch screen (1510), data-glove (not shown), joystick (1505), microphone (1506), scanner (1507), camera (1508).

Computer system (1500) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1510), data-glove (not shown), or joystick (1505), but there can also be tactile feedback devices that do not serve as input devices), audio output devices (such as: speakers (1509), headphones (not depicted)), visual output devices (such as screens (1510) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1500) can also include human accessible storage devices and their associated media such as optical media including CD/DVD ROM/RW (1520) with CD/DVD or the like media (1521), thumb-drive (1522), removable hard drive or solid state drive (1523), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1500) can also include an interface (1554) to one or more communication networks (1555). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1549) (such as, for example USB ports of the computer system (1500)); others are commonly integrated into the core of the computer system (1500) by attachment to a system bus as described below (for example Ethernet interface into a PC computer system or cellular network interface into a smartphone computer system). Using any of these networks, computer system (1500) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1540) of the computer system (1500).

The core (1540) can include one or more Central Processing Units (CPU) (1541), Graphics Processing Units (GPU) (1542), specialized programmable processing units in the form of Field Programmable Gate Areas (FPGA) (1543), hardware accelerators for certain tasks (1544), graphics adapters (1550), and so forth. These devices, along with Read-only memory (ROM) (1545), Random-access memory (1546), internal mass storage such as internal non-user accessible hard drives, SSDs, and the like (1547), may be connected through a system bus (1548). In some computer systems, the system bus (1548) can be accessible in the form of one or more physical plugs to enable extensions by additional CPUs, GPU, and the like. The peripheral devices can be attached either directly to the core's system bus (1548), or through a peripheral bus (1549). In an example, the screen (1510) can be connected to the graphics adapter (1550). Architectures for a peripheral bus include PCI, USB, and the like.

CPUs (1541), GPUs (1542), FPGAs (1543), and accelerators (1544) can execute certain instructions that, in combination, can make up the aforementioned computer code. That computer code can be stored in ROM (1545) or RAM (1546). Transitional data can also be stored in RAM (1546), whereas permanent data can be stored for example, in the internal mass storage (1547). Fast storage and retrieve to any of the memory devices can be enabled through the use of cache memory, that can be closely associated with one or more CPU (1541), GPU (1542), mass storage (1547), ROM (1545), RAM (1546), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1500), and specifically the core (1540) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1540) that are of non-transitory nature, such as core-internal mass storage (1547) or ROM (1545). The software implementing various aspects of the present disclosure can be stored in such devices and executed by core (1540). A computer-readable medium can include one or more memory devices or chips, according to particular needs. The software can cause the core (1540) and specifically the processors therein (including CPU, GPU, FPGA, and the like) to execute particular processes or particular parts of particular processes described herein, including defining data structures stored in RAM (1546) and modifying such data structures according to the processes defined by the software. In addition or as an alternative, the computer system can provide functionality as a result of logic hardwired or otherwise embodied in a circuit (for example: accelerator (1544)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A non-transitory computer-readable storage medium storing instructions which when executed by a processor cause the processor to perform an encoding method comprising:
determining whether to apply a geometric partitioning mode (GPM) including a GPM partition method with a weight w₀ to a current block, the weight w₀ being indicated by a nonlinear polynomial model and being of a first prediction of the current block that is obtained from a first prediction mode, the nonlinear polynomial model depending on at least one of x and y, (x, y) indicating a sample position in the current block;
when the GPM with the weight w₀ is applied to the current block, determining coefficients of the nonlinear polynomial model based on a current template of the current block and reference templates by template-matching, the current template including neighboring samples of the current block, each reference template being obtained based on the first prediction mode, a second prediction mode of the GPM, and a respective candidate nonlinear polynomial model having corresponding candidate coefficients;
encoding, in a bitstream, the current block based on a weighted average of the first prediction and a second prediction of the current block obtained using the second prediction mode according to the weight w₀; and
transmitting the encoded bitstream.

2. The non-transitory computer-readable storage medium of claim 1, wherein:
a degree of the nonlinear polynomial model is 2, w₀ is ax²+bx+cy²+dy+e, the determined coefficients include a, b, c, d, and e, and a weight w₁ of the second prediction is (1−w₀).

3. A method for video encoding, comprising:
determining whether to apply a geometric partitioning mode (GPM) including a GPM partition method with a weight w₀ to a current block, the weight w₀ being indicated by a nonlinear polynomial model and being of a first prediction of the current block that is obtained from a first prediction mode, the nonlinear polynomial model depending on at least one of x and y, (x, y) indicating a sample position in the current block;
when the GPM with the weight w₀ indicated by the nonlinear polynomial model is applied to the current block, determining coefficients of the nonlinear polynomial model based on a current template of the current block and reference templates by template-matching, the current template including neighboring samples of the current block, each reference template being obtained based on the first prediction mode, a second prediction mode of the GPM, and a respective candidate nonlinear polynomial model having corresponding candidate coefficients; and
encoding the current block based on a weighted average of the first prediction and a second prediction of the current block obtained using the second prediction mode according to the weight w₀.

4. The method of claim 3, wherein:
a degree of the nonlinear polynomial model is 2, w₀=ax²+bx+cy²+dy+e, the determined coefficients include a, b, c, d, and e; and
a weight w₁ of the second prediction is (1−w₀).

5. The method of claim 3, wherein:
a degree of the nonlinear polynomial model is 3, w₀=ax³+bx²+cx+dy³+ey²+fy+g, the determined coefficients include a, b, c, d, e, f, and g; and
a weight w₁ of the second prediction is (1−w₀).

6. The method of claim 3, wherein the determining comprises determining the coefficients of the nonlinear polynomial model using a regression method.

7. The method of claim 3, wherein the method comprises:
prior to determination of the coefficients of the nonlinear polynomial model, down-sampling an initial current template of the current block having a first resolution to obtain the current template having a second resolution, the second resolution being lower than the first resolution.

8. The method of claim 3, wherein:
encoding a syntax element indicating whether the weight w₀ is applied to the current block.

9. The method of claim 3, wherein:
encoding a syntax element indicating one of a plurality of types of GPM, and the plurality of types of GPM includes a type of GPM in which the weight w₀ is applied.

10. The method of claim 3, wherein:
the current template is one of a plurality of templates; and
the plurality of templates includes a top template that is directly above the current block, a left template that is directly to a left of the current block, and an L-shaped template including the top template and the left template.

11. An apparatus for video decoding, comprising:
processing circuitry configured to:
receive coded information indicating that a current block is coded with a geometric partitioning mode (GPM) using a first prediction mode and a second prediction mode;
determine coefficients of a nonlinear polynomial model that indicates a weight w₀ of a first prediction of the current block that is obtained from the first prediction mode, the coefficients being determined based on a current template of the current block and reference templates by template-matching, the current template including neighboring reconstructed samples of the current block, each reference template being obtained based on the first prediction mode, the second prediction mode, and a respective candidate nonlinear polynomial model having corresponding candidate coefficients, the nonlinear polynomial model depending on at least one of x and y, (x, y) indicating a sample position in the current block; and
reconstruct the current block based on a weighted average of the first prediction and a second prediction of the current block obtained using the second prediction mode according to the weight w₀.

12. The apparatus of claim 11, wherein a degree of the nonlinear polynomial model is 2, w₀=ax²+bx+cy²+dy+e, the determined coefficients include a, b, c, d, and e, and a weight w₁ of the second prediction is (1−w₀).

13. The apparatus of claim 11, wherein a degree of the nonlinear polynomial model is 3, w₀=ax³+bx²+cx+dy³+ey²+fy+g, the determined coefficients include a, b, c, d, e, f, and g, and a weight w₁ of the second prediction is (1−w₀).

14. The apparatus of claim 11, wherein the processing circuitry is configured to determine the coefficients of the nonlinear polynomial model using a regression method.

15. The apparatus of claim 11, wherein the processing circuitry is configured to:
prior to determination of the coefficients of the nonlinear polynomial model, down-sample an initial current template of the current block having a first resolution to obtain the current template having a second resolution, the second resolution being lower than the first resolution.

16. The apparatus of claim 11, wherein:
the coded information includes a syntax element indicating whether the weight w₀ is applied to the current block; and
the processing circuitry is configured to determine whether the weight w₀ is applied to the current block based on the syntax element.

17. The apparatus of claim 11, wherein:
the coded information includes a syntax element indicating one of a plurality of types of GPM, and the plurality of types of GPM includes a type of GPM in which the weight w₀ is applied.

18. The apparatus of claim 11, wherein:
the current template is one of a plurality of templates; and
the plurality of templates includes a top template that is directly above the current block, a left template that is directly to a left of the current block, and an L-shaped template including the top template and the left template.

19. The apparatus of claim 18, wherein:
the coded information includes a syntax element of the current block indicating the current template; and
the processing circuitry is configured to determine the current template as one of:
the L-shaped template when the syntax element is 0;
the left template when the syntax element is 1; and
the top template when the syntax element is 2.

20. The apparatus of claim 11, wherein:
the coded information includes a syntax element indicating whether the current template is selected from a plurality of templates; and
when the syntax element is determined to indicate that the current template is selected from the plurality of templates, the processing circuitry is configured to determine the current template as one of the plurality of templates based on another syntax element in the coded information.
